(19) United States
(12) Patent Application Publication
(10) Pub. No.: US 2012/0115394 A1
(43) Pub. Date: May 10, 2012

(54) Closed-Loop Adaptive Two-Way Remote Controller

(76) Inventor: Michael Sivan, Shatin-Fotan (HK)

(21) Appl. No.: 12/940,081

(22) Filed: Nov. 5, 2010

(51) Int. Cl. A63H 29/22; G01J 5/00

(52) U.S. Cl. 446/484; 250/338.1

(57) ABSTRACT

An adaptive remote control unit that automatically reads the changing real-time physical orientation of its remote controlled object, or other of its momentary features, and henceforth transmits commands to the remote controlled object that are a function of such reading as well as a function of user's own input control, for the purpose of achieving a unique pre-defined movement pattern, or otherwise adjust the behavior of the object in relations to its real time situation.

### TECHNICAL FIELD

Remote Control for Toys

### BACKGROUND

Prior art wireless remote control systems (‘RCS’) for toys comprise of a hand-held control unit (‘RCU’); and a command receiving unit (‘RX’) situated on the moving toy. The RCU has a set of activation controls typically embodied as joysticks, buttons, levers, switches, tilt sensors, etc. (‘Controls’). When user wishes to send a specific remote movement command, user manipulates the respective Control on the RCU, and in response the RCU transmits a respective encoded signal, typically by Infra-Red (‘UR’) or radio frequency. The RX receives that I/R or radio signal, decodes it into electronic signals which then drive the respective motors causing the toy to react in a manner which was required by the user.

However, prior art RCS work in open-loop. The I/R or radio transmitted signals reflect only the input of the user through the Controls of the RCU. The RCU is blind to, and does not respond to, the real time direction, speed, position, height, obstacles facing the toy, or elsewise. In fact, the RCU is oblivious to existence of the toy. The loop is closed by the user itself, who SEES the toy and its movement, and then RESPOND respectively by manipulating the RCU Controls.

This absolute dependence on what the user sees with his/her own eyes—poses limits in usage of such RCS. Example, a quick rotation of a toy helicopter around itself may confuse the user and he/she will not know whether to command ‘right’ or ‘left’ to avoid the helicopter from crashing into a wall or an obstacle. Another example—the reversing effect—if user wishes to make the helicopter approach him, he needs to command FORWARD if the toy is facing him, or BACKWARDS if the toy's back is towards him. Similarly, left and right also get inversed in respect to the orientation of the helicopter. This is not only confusing, especially to first time users of remote controlled helicopters, but also limits various gameplays.

The present invention provides for a closed-loop remote control unit that automatically and in real-time reads the physical orientation of a moving toy relative to the RCU, and henceforth the RCU automatically adapts itself to transmit to the moving toy remote control commands which are not only a function of the Control lever that the user manipulated, but the commands are also a function of the real time change in the orientation of the moving toy. Examples:
a. Follow-me helicopter—just by carrying the RCU in his hands, a helicopter will automatically follow the user anywhere he goes.
b. Non-reversing remote-control for helicopters (or toy cars)—the helicopter will move in the desired direction regardless to its momentary orientation in space. The implementation requires one single common I/R sensor only on the toy (whereas other methods may require four I/R sensors or more, bearing in mind that cost of common I/R sensors is still high for toys costing structure).
c. Pre-defined automatic flight patterns—as an example automatic take-off and landing of a helicopter from a pre-defined landing zone.

### SUMMARY OF INVENTION

The present invention is best explained with the embodiment of a remote control toy helicopter as follows:

Typical prior art remote control system in a toy helicopter (‘Helico’) consists of a hand controller (‘RCU’), see block diagram in FIG. 1, which receives commands 11 from the user (using joysticks and other buttons). Control Unit 12 encodes the commands and transmits them via an Infra-Red (‘I/R’) LED 13. The Helico (FIG. 2) consists of an I/R sensor 22, which converts the I/R signal 21 into a binary electronics signal that is fed into the Movement Control Unit 23 and thereafter decoded to drive the 3 motors of the Helico.

The present invention comprises of Adaptive RCU (‘ARCU’) and a modified new Helico (FIG. 3). The ARCU adds one I/R sensor 31 which connects to the Control Unit 32. The new Helico adds a Control Unit (FIG. 4, part 44) to which four I/R LEDs 46-49 are connected. For further reduction of costs, control units 44 and 23 could be merged into one control unit.

The four LEDs are positioned with their main axes pointing horizontally and away in four corners of the Helico (FIG. 4).

Each of the 4 LEDs 46-49 is directional (FIG. 5). I.e. the signal strength measured in a given distance is the strongest 52 when the measuring place is in the main axis 51, weaker in 53 and even weaker in 54. If the LEDs are not directional, then each LED can perform as a directional LED by adding I/R light obstructing element 55 (e.g. a cylindrical tube).

Each of the 4 LEDs 46-49 transmits a packet (FIG. 6 parts 61-63). The packets are each allocated a respective time slot 66-69 assigned by Control Unit 44 The purpose of which is to avoid interference of signals.

The I/R sensor 72 (FIG. 7) located at a distance at an angle 71 will receive signals from at least two of the sensors 46-49. The relative signals strengths will correspond to the angle 71. As an example, if signals from LEDs 46 and 47 are equal, and also stronger than signals from 48 and 49, then the angle 71 is 90 deg. If signal from 46 is stronger than all others, as well as 47 is stronger than 49, then the angle is larger than 45 deg but less than 90 deg.

The preferred method of measuring the signals strengths at low cost is by using a single common I/R sensor on the ARCU and transmitting from the Helico four directional I/R signals, each from one directional LED (as described above), and all signals are amplitude modulated (AM) with a saw tooth 63 on a carrier of 38 KHz. Each I/R signal that reaches sensor 31 of the RCU is converted to an electronic signal 81 (see FIG. 8). Signal 81 continues through the band-pass filter 82 centered around 38 KHz which strips away most of the ambient noise. Signal 83 is then AM demodulated by 84 which strips away the 38 KHz carrier and leaves signal 85.

FIG. 9 depicts, as an example, 4 I/R signals received at the sensor coming from the 4 different LEDs. The sensor has a given threshold 91. Any signal 81 stronger than that threshold will change the binary state of signal 85 and vice versa. Because the 4 LEDs transmit a saw-tooth signal as per FIG. 6—the lengths in time of the signal 85 will be as shown in 92 time line—T1 to T4.

This method provides for binary signal 81 length to be in direct proportion to the strength of the received I/R signal. Accordingly, the Control Unit 32 will count the length of each binary signal and conclude derive the relative signal strength of each of the 4 LEDs.

### EXAMPLE 1

### Follow Me Car

Controller 44, transmits through I/R LEDs 46-49 and 42 the timed signals as per FIG. 6. Each I/R signal is binary coded, on top of a 38 KHz carrier. Each I/R LED sends a packet having 3 parts:—(a) A preamble 61, (b) a middle part 62 which encodes the id of the LED; and (c) a saw-tooth modulated part 63.

The ARCU receives all I/R signals through sensor 31. Making use of the DMT method the Control Unit 32 of the RCU determines the relative strength of the signal received from each of the 4 LEDs 46-49. and consequently the angle 71 which is, in fact, the physical angle between the front of the car and position of the ARCU.

Thereafter, the ARCU automatically emits an I/R signal encoded with the control command RIGHT or LEFT which will cause the car to turn towards the ARCU so as to face the ARCU. As this is a closed-loop process, the command will stop when the car faces the ARCU, and in that moment the car freezes in that direction.

Thereafter, the ARCU continues to issue the FWD command until the car reaches a minimal pre-determined distance from the ARCU, which will be indicated by signal strengths of LEDs 46 and 49 (I.e. NE and NW) stronger than a specific threshold.

### Avoidance of Interference

Control Unit 44 controls the packets sent out by LEDs 46-49. After every cycle there is an empty time slot 65 in which the control unit is listening to signals transmitted by the ARCU. The ARCU receives the packets sent by 46-49 and thus will synchronize its own transmission time to match the time slot 65.

### BRIEF DESCRIPTION OF DRAWINGS

FIG. 1 Prior art Remote Control Unit block diagram

FIG. 2 Prior art Helicopter block diagram

FIG. 3 Adaptive Remote Controller Unit Block Diagram

FIG. 4 New Helicopter Block Diagram

FIG. 5 Directional I/R LED emission pattern

FIG. 6 Directional Multiple Transmission timing

FIG. 7 Top View of the 4 I/R LEDs

FIG. 8 I/R Sensor functionality

FIG. 9 The Saw Tooth Signal Strength gauging Method

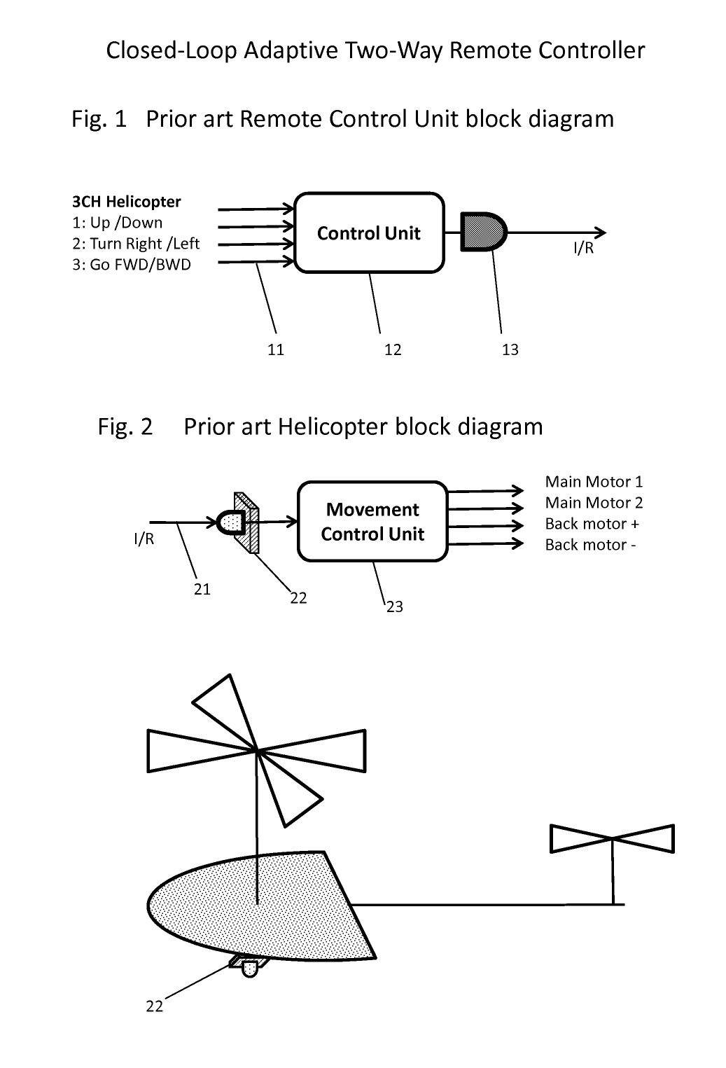

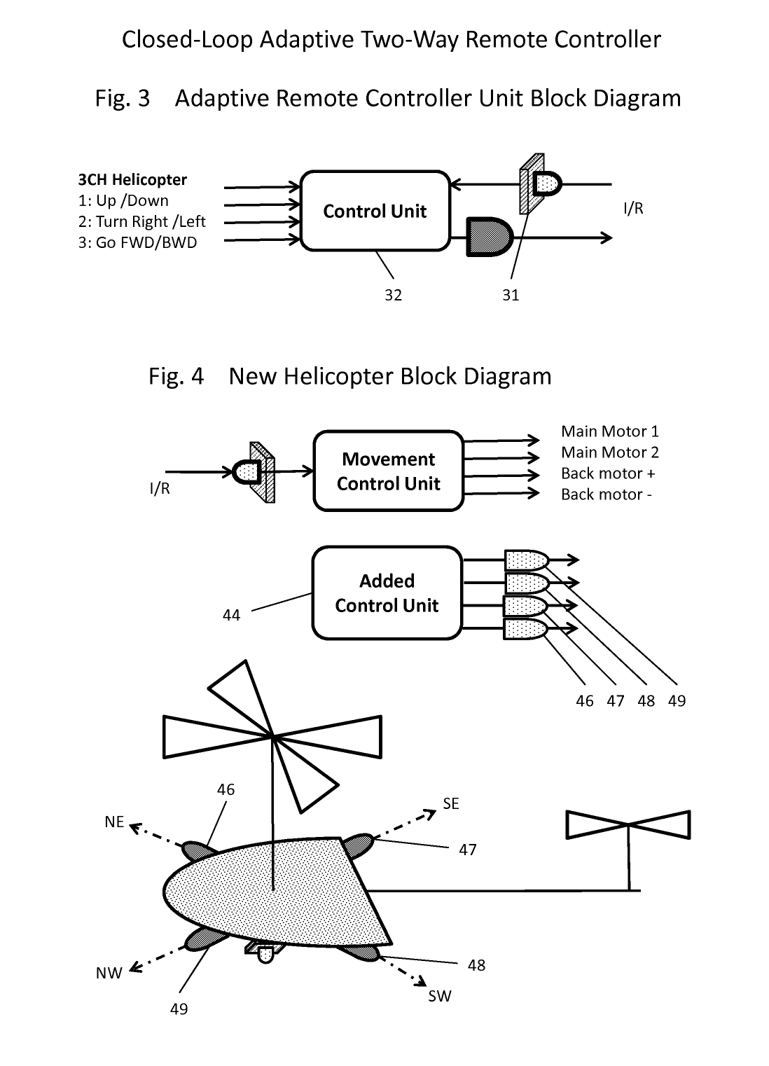

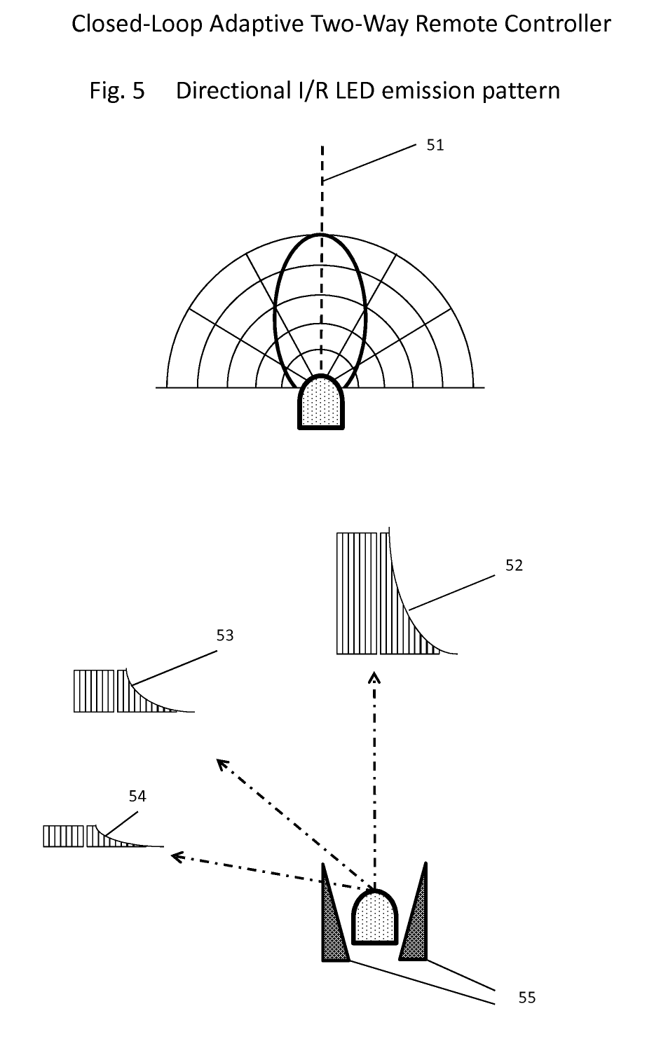

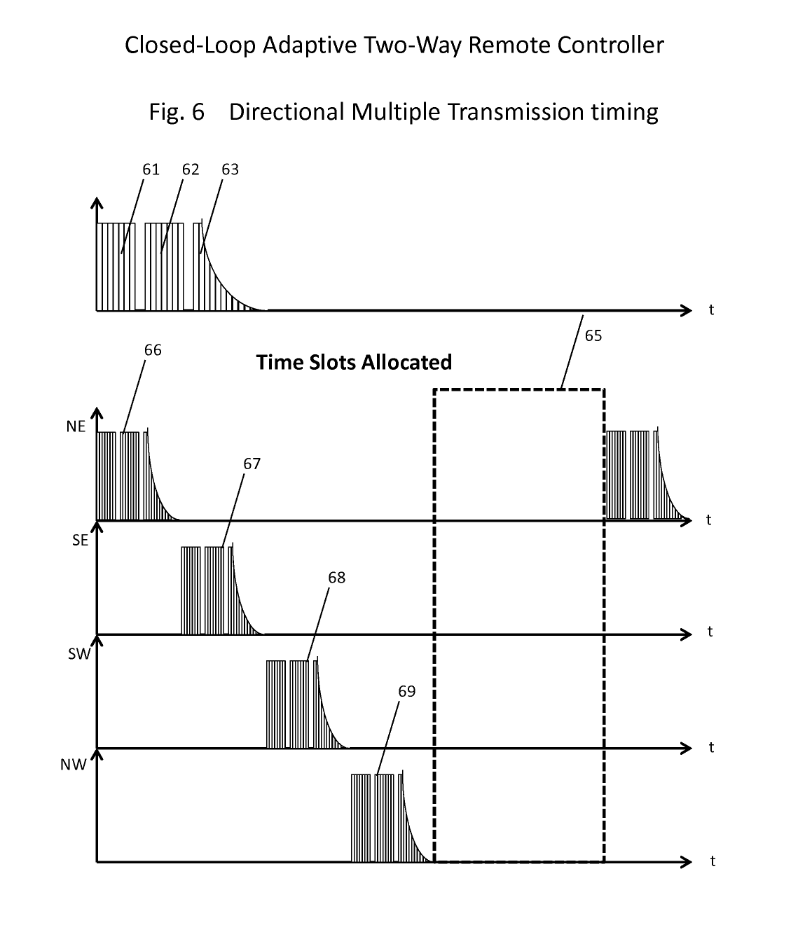

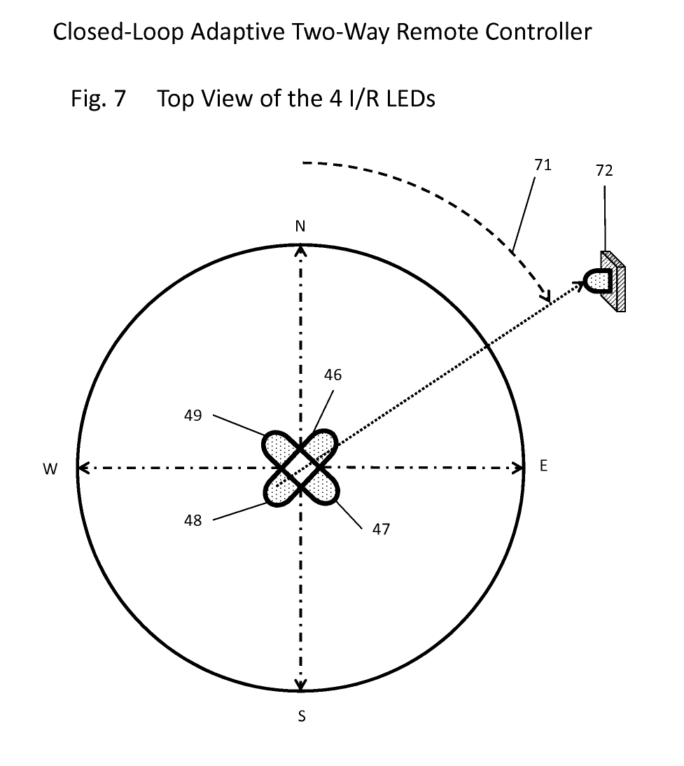

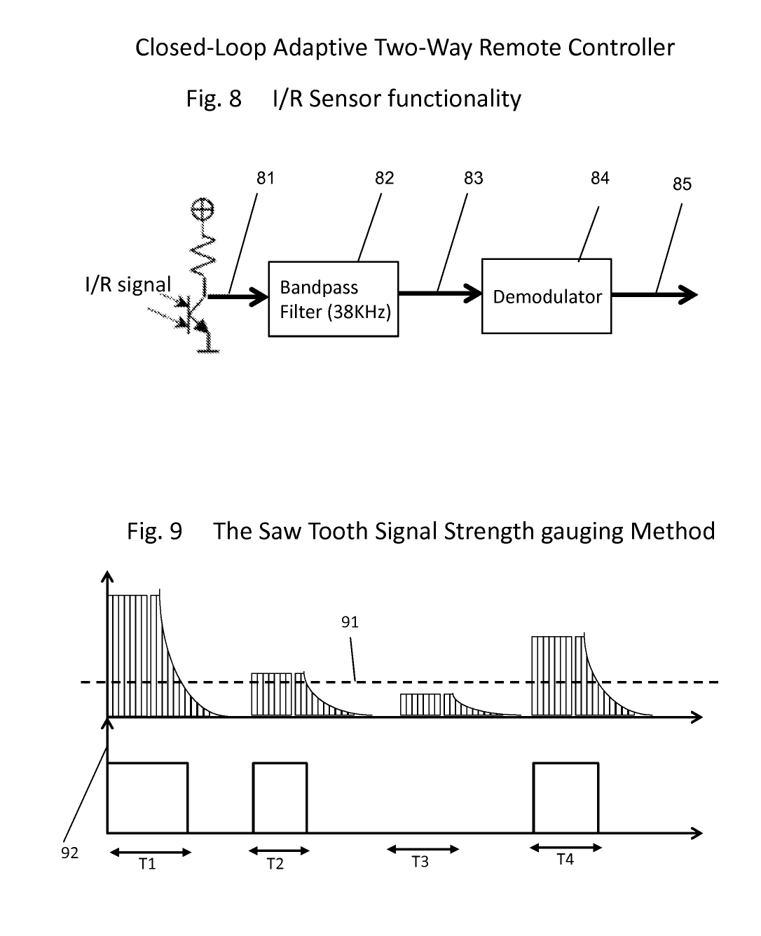

1. A remote orientation-detection system comprising of a target unit and a remote unit wherein the target unit comprises of: two Infra-Red (‘UR’) LEDs, each LED configured by its own physical structure or by added surrounding I/R light absorbing materials, to emit a maximum intensity of I/R light in direction of its main axis, and a reduced intensity of I/R light in other directions in inverse proportion to the angle between the main axis and the other directions; the LEDs are positioned in front of the target unit with their main axes in a horizontal orientation spread out to the left and the right of the main axis of the target unit at preferred angle of 60-120 degrees between themselves and configured in such way that the relative strengths of the received two LEDs at any angle in front of the target will be different and as such allowing to calculate such angle; the I/R LEDs are connected to a control unit inside the target unit configured to transmit via each LED a train of saw tooth pulses modulated on a 38 KHz carrier, each train timed in such way not to overlap pulses from one LED with the other; each LED's signal includes also an id code to uniquely identify that LED;
The remote unit comprises of an I/R sensor and a control unit configured to gauge and compare the relative strengths between the received signals from the LEDs and accordingly determine the orientation of the target unit relative to the remote unit.

2. The remote orientation-detection system of claim 1 comprising of 3 or more I/R LEDs, their main axes spread out from the target unit either in same plane, horizontal or otherwise, or in any other 3D direction.

3. The remote orientation-detection system of claim 1 or 2 configured to use frequency shift modulation (FM) of the 38 KHz carrier signal rather than the saw tooth modulation (AM); or any other modulation which allows usage of a preferably common I/R sensor, or any other I/R sensor, to measure the signal strength.

4. A closed loop adaptive remote control system comprising of a flying unit (‘FLU’) in any shape of helicopter, plane, UFO or other; and an adaptive remote control unit (‘ARCU’); wherein the FLU comprises of at least two motors configured to drive at least two rotors which are configured to provide at least vertical and yaw movements to the FLU; at least one Infra-Red (‘UR’) sensor or radio frequency receiver configured to receive wireless I/R or radio signals and convert them into electronic signals; at least two I/R LEDs and controller configured for (a) remote orientation-detection as provided in the target unit described in either claim 1, 2 or 3, and (b) for conversion of the electronic signals (received from the I/R sensor or radio receiver) into commands to drive the motors; and
an ARCU comprising of at least one I/R LED or radio frequency transmitter; at least one user manipulated input device such as but not limited to switch, button, lever, joystick, tilt sensor, microphone, touch sensor, etc.; at least one I/R sensor and a control unit configured to (a) remote orientation-detection as provided in the remote unit described in either claim 1, 2 or 3; and (b) to receive and process the signals from the input devices; (c) to transmit to the FLU movement commands which are a function of both (a) and (b) and thus creating a flight pattern on the FLU, such configured to be one or a combination of (i) follow me flight pattern, in which the FLU will follow the ARCU; (ii) non-reversing remote control, in which the movement commands refer to the position of the ARCU; (iii) auto take-off and/or landing in a pre-defined area; (iv) automatic hovering in a pre-defined place without drift away; (v) automatic sequence of movements which resembles dancing, marching and which may respond to music or other sound; (vi) any other pre-defined flight pattern.

5. A closed loop adaptive remote control system as described in claim 4 wherein the FLU is replaced by a toy that can move on ground, wall, ceiling or in water.

6. A closed loop adaptive remote control system as described in claim 5 wherein the remote orientation-detection system is not included and the ARCU is configured to transmit automatic commands to a remote controlled object, such commands are a function of real-time information gathered by the ARCU from the controlled object, and possibly also a function of user's manipulation of the input controls of the ARCU position; wherein the real-time information from the controlled object could be light, sound, temperature reading, movement, electromagnetic waves in any frequency, and others; and wherein the control commands could be to create movements of the controlled object, or make any changes in the controlled object in relations to the emitted light, sound, electromagnetic waves, object's temperature and similar.
